(19) United States
(12) Patent Application Publication
(10) Pub. No.: US 2015/0052444 A1
(43) Pub. Date: Feb. 19, 2015

(54) METHOD OF DISPLAYING A DLNA APPARATUS, AND MOBILE TERMINAL

(71) Applicant: HUIZHUO TCL MOBILE COMMUNICATION CO., LTD., Huizhou, Guangdong (CN)

(72) Inventor: Wendi Cai, Huizhou (CN)

(73) Assignee: HUIZHOU TCL MOBILE COMMUNICATION CO., LTD, Huizhou, Guangdong (CN)

(21) Appl. No.: 14/387,147

(22) PCT Filed: Jul. 11, 2013
(86) PCT No.: PCT/CN2013/079210

§ 371 Date: Sep. 22, 2014

(30) Foreign Application Priority Data
Dec. 12, 2012 (CN) 201210541126.0

(51) Int. Cl. H04L 29/08; G06F 3/0484; H04L 12/751; G06F 3/0481

(52) U.S. Cl. CPC H04L 67/141; G06F 3/04817; G06F 3/04842; H04L 45/02
USPC 715/738

(57) ABSTRACT

Disclosed are a method and mobile terminal for displaying DLNA equipment the method comprising accessing the DLNA network through wireless communication obtaining the DLNA equipment in the DLNA network; adding the DLNA equipment to a DLNA list which is correspondingly related to a shortcut icon; displaying the shortcut icon at the predetermined position of the display interface; entering the DLNA list by clicking on the shortcut icon to choose and operate the DLNA equipment. By said means, the method and the mobile terminal for displaying DLNA equipment can simplify the operating steps, and improve the efficiency of operating DLNA equipment for user.

### FIELD OF THE INVENTION

The present disclosure relates to the technical field of mobile communication technologies, and more particularly to a method of displaying a DLNA apparatus, and a mobile terminal.

### BACKGROUND OF THE INVENTION

The DLNA (Digital Living Network Alliance) is a kind of technical solution that allows for interconnection and intercommunication among personal computers, consumer electrical appliances, mobile apparatuses or the like in a wireless network or a wired network so as to achieve the purpose of unlimited sharing of digital media and content services.

Conventionally, before a user uses a mobile phone to access an apparatus in a DLNA network, it needs to perform a series of complex operations. For example, it needs to access a wireless network and search for a connectable DLNA apparatus in the current network, select a target apparatus type in a medium library list that is displayed, then perform subsequent operations after the target apparatus type is selected, and finally select the name of the DLNA apparatus. This makes the user unable to operate the DLNA apparatus conveniently and quickly, thus leading to a poor efficiency.

### SUMMARY OF THE INVENTION

A primary object of the present disclosure is to provide a method of displaying a DLNA apparatus, and a mobile terminal which are capable of simplifying the operation steps.

To solve the aforesaid technical problem, a technical solution adopted in the present disclosure is to provide a method of displaying a DLNA apparatus, which comprises: accessing a DLNA network via a wireless mode; acquiring a DLNA apparatus in the DLNA network; determining whether the DLNA apparatus is in a connectable status, and adding the DLNA apparatus to a DLNA list if the DLNA apparatus is in a connectable status, or acquiring other DLNA apparatuses in the DLNA network if the DLNA apparatus is not in a connectable status, wherein the DLNA list is correspondingly related to a shortcut icon; concealing the shortcut icon in a display interface; calling the shortcut icon in response to a user's activation operation on the display interface; displaying the shortcut icon at a predetermined position; entering the DLNA list by clicking the shortcut icon to select and operate the DLNA apparatus.

The display interface is a touch interface, and the activation operation is a downward sliding action from the predetermined position.

The DLNA network is a wireless network or a wired network.

To solve the aforesaid technical problem, another technical solution adopted in the present disclosure is to provide a mobile terminal, which comprises an accessing module, an acquiring module, an adding module, a displaying module and a selecting module. The accessing module is configured to access a DLNA network via a wireless mode; the acquiring module is configured to acquire a DLNA apparatus in the DLNA network; the adding module is configured to add the DLNA apparatus to a DLNA list, wherein the DLNA list is correspondingly related to a shortcut icon; the displaying module is configured to display the shortcut icon at a predetermined position on a display interface; and the selecting module is configured to enter the DLNA list by clicking the shortcut icon to select and operate the DLNA apparatus.

The adding module is specifically configured to determine whether the DLNA apparatus is in a connectable status, and add the DLNA apparatus to the DLNA list if the DLNA apparatus is in a connectable status, or acquire other DLNA apparatuses in the DLNA network if the DLNA apparatus is not in a connectable status.

The displaying module is specifically configured to conceal the shortcut icon in the display interface; call the shortcut icon in response to a user's activation operation on the display interface; and display the shortcut icon at the predetermined position.

The display interface is a touch interface, and the activation operation is a downward sliding action from the predetermined position.

The DLNA network is a wireless network or a wired network.

To solve the aforesaid technical problem, a further technical solution adopted in the present disclosure is to provide a method of displaying a DLNA apparatus, which comprises the following steps of: accessing a DLNA network via a wireless mode; acquiring a DLNA apparatus in the DLNA network; adding the DLNA apparatus to a DLNA. list, wherein the DLNA list is correspondingly related to a shortcut icon; displaying the shortcut icon at a predetermined position on a display interface; and entering the DLNA list by clicking the shortcut icon to select and operate the DLNA apparatus.

The step of adding the DLNA apparatus to a DLNA list is specifically as follows: determining whether the DLNA apparatus is in a connectable status, and adding the DLNA apparatus to the DLNA list if the DLNA apparatus is in a connectable status, or acquiring other DLNA apparatuses in the DLNA network if the DLNA apparatus is not in a connectable status.

The step of displaying the shortcut icon at a predetermined position on a display interface comprises: concealing the shortcut icon in the display interface; calling the shortcut icon in response to a user's activation operation on the display interface; and displaying the shortcut icon at the predetermined position.

The display interface is a touch interface, and the activation operation is a downward sliding action from the predetermined position.

The DLNA network is a wireless network or a wired network.

To solve the aforesaid technical problem, a still further technical solution adopted in the present disclosure is to provide a mobile terminal, which comprises an accessing module, an acquiring module, an adding module, a displaying module and a selecting module. The accessing module is configured to access a DLNA network via a wireless mode; the acquiring module is configured to acquire a DLNA apparatus in the DLNA network; the adding module is configured to add the DLNA apparatus to a DLNA list, wherein the DLNA list is correspondingly related to a shortcut icon; the displaying module is configured to display the shortcut icon at a predetermined position on a display interface; and the selecting module is configured to enter the DLNA list by clicking the shortcut icon to select and operate the DLNA apparatus.

The adding module is specifically configured to determine whether the DLNA apparatus is in a connectable status, and add the DLNA apparatus to the DLNA list if the DLNA apparatus is in a connectable status, or acquire other DLNA apparatuses in the DLNA network if the DLNA apparatus is not in a connectable status.

The displaying module is specifically configured to conceal the shortcut icon in the display interface; call the shortcut icon in response to a user's activation operation on the display interface; and display the shortcut icon at the predetermined position.

The display interface is a touch interface, and the activation operation is a downward sliding action from the predetermined position.

The DLNA network is a wireless network or a wired network.

The present disclosure has the following benefits: entering a DLNA list by clicking a shortcut icon on a display interface can simplify the operation steps; and because a user can directly enter a DLNA list in the display interface, it is more convenient for the user to operate and the operation efficiency of the user on a DLNA apparatus can be enhanced.

### BRIEF DESCRIPTION OF THE DRAWINGS

FIG. 1 is a schematic flowchart diagram of a method of displaying a DLNA apparatus according to an embodiment of the present disclosure;

FIG. 2 is a schematic view illustrating the specific process flow of the method shown in FIG. 1;

FIG. 3 is a schematic view illustrating the specific process flow of displaying a shortcut icon in the method shown in FIG. 1; and

FIG. 4 is a schematic structural view of a mobile terminal according to an embodiment of the present disclosure.

### DETAILED DESCRIPTION OF THE INVENTION

The present disclosure will be detailed hereinbelow with reference to the attached drawings and the embodiments.

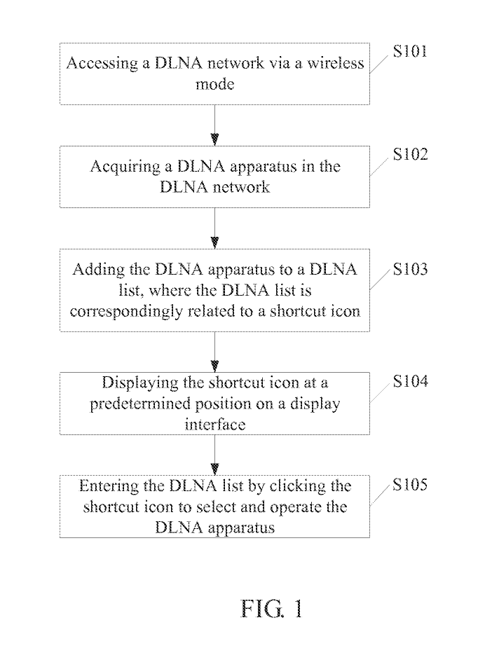

Refer to FIG. 1, which shows a schematic flowchart diagram of a method of displaying a DLNA apparatus according to an embodiment of the present disclosure. The method of displaying a DLNA apparatus comprises the following steps of:

Step S101: accessing a DLNA network via a wireless mode.

The DLNA network, also known as the home network, is a home informatization platform that integrates the home control network with the multimedia information network. The DLNA network can achieve interconnection and management of information apparatuses, communication apparatuses, entertainment apparatuses as well as household electrical appliances in the family range, and is a system in which the data information and the multimedia information can be shared. The DLNA network system forms an intelligent home apparatus system. In this embodiment, the DLNA network is a virtual network based on the 802.11 wireless network or wired network. The DLNA network labels DLNA apparatuses that are connected into the DLNA network, and all DINA apparatuses that are connected into the network can share resources and intemperate with each other. For example, if an electronic apparatus that sets up the DLNA network is a computer, then by setting the type of the wireless network of the computer to be a “home network”, the “home network” will be the DLNA network. When electronic apparatuses that support the DLNA function in the household are connected into the DLNA network and it is ensured that the DLNA function of all electronic apparatuses that are connected into the DLNA network is activated, the electronic apparatuses can detect each other and establish communications therebetween.

Step S102: acquiring a DLNA apparatus in the DLNA network.

The electronic apparatuses that support the DLNA function are called DLNA apparatuses. After being connected into the DLNA network and having activated the DLNA function, the DLNA apparatuses can be detected with each other. By use of one of the DLNA apparatuses, the user can acquire other DLNA apparatuses in the DLNA network to conveniently control and operate the other DLNA apparatuses.

Step S103: adding the DLNA apparatus to a DLNA list, where the DLNA list is correspondingly related to a shortcut icon.

The DLNA apparatus is added to the DLNA list. The DLNA list may be created by a lower-layer service component of the DLNA apparatus, and is correspondingly related to the shortcut icon. The shortcut icon is a quick-start program provided by the DLNA apparatus, and is equivalent to a shortcut to open the DLNA list. The user can enter the interface of the DLNA list by clicking the shortcut icon.

Step S104: displaying e shortcut icon at a predetermined position of a display interface.

The display interface is the home screen interface of the DLNA apparatus, and the is predetermined position is a position on the home screen interface of the DLNA apparatus at which the shortcut icon corresponding to the DLNA list is displayed. It should be appreciated that, the predetermined position is not fixed, but may be an arbitrary position on the home screen interface of the DLNA apparatus; and when the shortcut icon is displayed at a certain position on the home screen interface of the DLNA apparatus, the certain position is just considered as the predetermined position. In this embodiment, if the DLNA apparatus has a pull-down menu bar, for example, if the DLNA apparatus is a mobile phone and a shortcut icon corresponding to the DLNA list is also provided in the pull-down menu bar of the mobile phone, it will become more convenient for the user to enter the DLNA list.

Step S105: entering the DLNA list by clicking the shortcut icon to select and operate the DLNA apparatus.

The user enters the DLNA list by clicking the shortcut icon, and then the DLNA apparatuses are listed out in the DLNA list so that the user can select and operate a corresponding DLNA apparatus depending on his or her own needs.

According to the above description, by accessing the DLNA network via the wireless mode to acquire a DLNA apparatus in the DLNA network, adding the DLNA apparatus to the DLNA list (where the DLNA list is correspondingly related to a shortcut list), displaying the shortcut icon at the predetermined position on the display interface, and entering the DLNA list by clicking the shortcut icon to select and operate the DLNA apparatus, the operation steps can be simplified in this embodiment. Because the user can directly enter the DLNA list in the display interface, it is convenient for the user to operate, and the operation efficiency of the user on the DLNA apparatus can be enhanced.

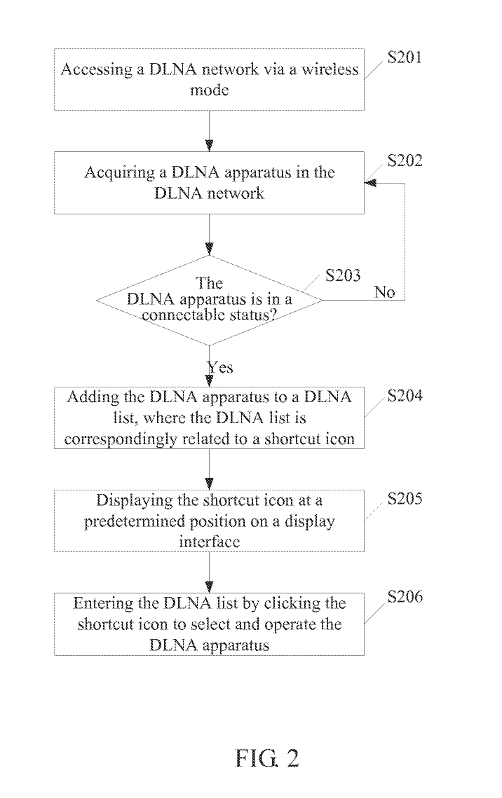

Refer to FIG. 2, which shows a schematic view illustrating the specific process flow of the method shown in FIG 1. The specific process flow of the method comprises the following steps of:

Step S201: accessing a DLNA network via a wireless mode.

The DLNA network is also known as the home network. For example, if the electronic apparatus that sets up the DLNA network is a computer, then by setting the network type of the computer to be a “home network”, the “home network” will be the DLNA network. In this embodiment, the DLNA network is a virtual network based on the 802.11 wireless network or wired network. The DLNA network labels the DLNA apparatuses that are connected into the DLNA network, and all DLNA apparatuses that are connected into the network can share resources and interoperate with each other. When electronic apparatuses that support the DLNA function in the household are connected into the DLNA network and it is ensured that the DLNA function of all electronic apparatuses that are connected into the DLNA network is activated, the electronic apparatuses can detect each other and establish communications therebetween.

Step S202: acquiring a DLNA apparatus in the DLNA network.

By using one of the DLNA apparatuses, the user can acquire other DLNA apparatuses in the DLNA network, and can conveniently control other DLNA apparatuses via the one DLAN apparatus.

Step S203: determining whether the DLNA apparatus is in a connectable status, and proceeding to step S204 if the DLNA apparatus is in a connectable status, or returning to step S202 if the DLNA apparatus is not in a connectable status.

Whether the DLNA apparatus is in a connectable status is determined. The connectable status is a DLNA network connectable status. If the DLNA apparatus is in the DLNA network connectable status, then connect the DLNA apparatus to the DLNA network and perform subsequent steps; and if the DLNA apparatus is not in the DLNA network connectable status, keep acquiring other DLNA apparatuses in the DLNA network until all DLNA apparatuses in the DLNA network are acquired.

Step S204: adding the DLNA apparatus to a DLNA list, where the DLNA list is correspondingly related to a shortcut icon.

The DLNA apparatus is added to the DLNA list, The DLNA list may be established by a lower-layer service component of the DLNA apparatus, and is correspondingly related to the shortcut icon. The user may enter the interface of the DLNA list by clicking the shortcut icon.

Step S205: displaying the shortcut icon at a predetermined position on a display interface.

The display interface is the home screen interface of the DLNA apparatus. The predetermined position is a position on the home screen interface of the DLNA apparatus at which the shortcut icon corresponding to the DLNA list is displayed. In this embodiment, if the DLNA apparatus has a pull-down menu bar, for example, if the DLNA apparatus is a mobile phone and a shortcut icon corresponding to the DLNA list is also provided in the pull-down menu bar of the mobile phone, it will become more convenient for the user to enter the DLNA list.

Step S206: entering the DLNA list by clicking the shortcut icon to select and operate the DLNA apparatus.

The user enters the DLNA list by clicking the shortcut icon, and then the DLNA apparatuses are listed out in the DLNA list so that the user can select and operate a corresponding DLNA apparatus depending on his or her own needs.

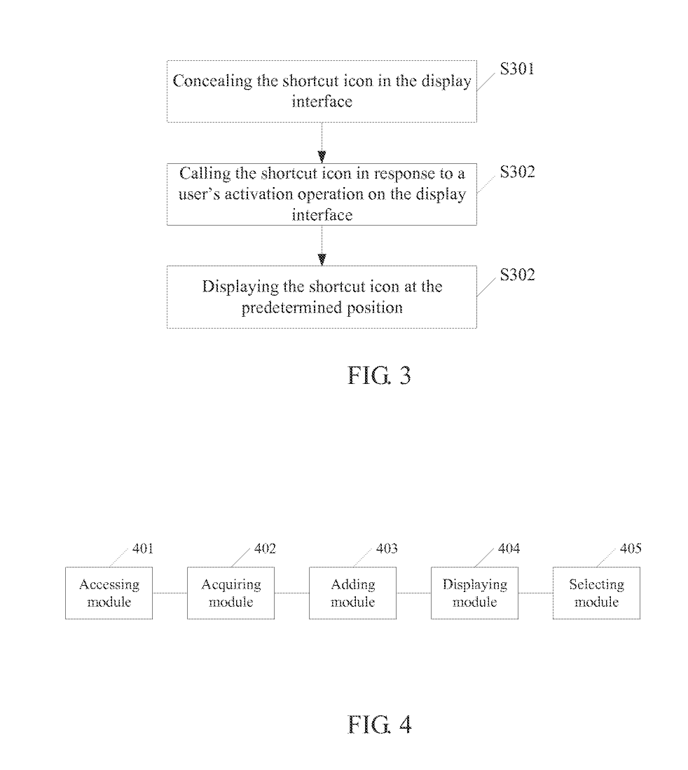

Refer to FIG. 3, which shows a schematic view illustrating the specific process flow of displaying a shortcut icon in the method shown in FIG. 1. Step S104 specifically comprises:

Step S301: concealing the shortcut icon in the display interface.

A time interval is preset in the DLNA apparatus. If the user has not clicked the shortcut icon during the time interval, that is, if the user has not executed any operation by using the shortcut icon during the time interval, the shortcut icon will be concealed in the display interface of the DLNA apparatus.

Step S302: calling the shortcut icon in response to a user's activation operation on the display interface.

The display interface is a touch interface, and the activation operation is a downward sliding action at a position on the home screen interface of the DLNA apparatus at which the shortcut icon is displayed, and then the DLNA apparatus to call the shortcut icon in response to the activation operation,

Ste S303: displaying the shortcut icon at the predetermined position.

When the shortcut icon is called by the DLNA apparatus, the shortcut icon is displayed at the predetermined position so that the subsequent operation can be performed.

Refer to FIG. 4, which shows a schematic structural view illustrating a mobile terminal according to an embodiment of the present disclosure. The mobile terminal comprises an accessing module 401, an acquiring module 402, an adding module 403, a displaying module 404 and a selecting module 405. The mobile terminal may be a mobile phone, a notebook computer or a tablet computer, all of which belong to the DLNA apparatuses in the DLNA network.

The accessing module 401 is configured to access a DLNA network via a wireless mode. The DLNA network is also called the home network. In this embodiment, the DLNA network is a virtual network based on the 802.11 wireless network or wired network, and labels the DLNA apparatuses that are connected into the DLNA network. All DLNA apparatuses that are connected into the network can share resources and interoperate with each other. For example, if the electronic apparatus that sets up the DLNA network is a computer, the by setting the type of the wireless network of the computer to be a “home network”, the “home network” will be the DLNA network. When electronic apparatuses that support the DLNA function in the household are connected into the DLNA network and it is ensured that the DLNA function of all electronic apparatuses that are connected into the DLNA network is activated, the electronic apparatuses can detect each other and establish communications therebetween.

The acquiring module 402 is configured to acquire a DLNA apparatus in the DLNA network. By use of one of the DLNA apparatuses, the user can acquire other DLNA apparatuses in the DLNA network to conveniently control other DLNA apparatuses via the one DLNA apparatus.

The adding module 403 is configured to add the DLNA apparatus to a DLNA list, where the DLNA list is correspondingly related to a shortcut icon. The DLNA apparatus is added to the DLNA list. The DLNA list is established by a lower-layer service component of the DLNA apparatus, and is correspondingly related to the shortcut icon. The user can enter the display interface of the DLNA list by clicking the shortcut icon.

The displaying module 404 is configured to display the shortcut icon at a predetermined position on a display interface.

The display interface is the home screen interface of the DLNA apparatus, and the home screen interface of the DLNA apparatus is a touch interface. The predetermined position is a position on the home screen interface of the DLNA apparatus at which the shortcut icon corresponding to the DLNA list is displayed. It should be appreciated that, the predetermined position is not fixed, and any position on the home screen interface of the DLNA apparatus can be set to be the predetermined position.

Further, a time interval may be preset in the DLNA apparatus. If the shortcut icon is not used by the user during the time interval, then the shortcut icon will be concealed.

The display interface is a touch interface, and the activation operation is a downward sliding action at a position on the home screen interface of the DLNA apparatus at which the shortcut icon is displayed, and then the DLNA apparatus calls the shortcut icon in response to the activation operation.

After the shortcut icon is called by the DLNA apparatus, the shortcut icon is displayed at the predetermined position so that subsequent operation can be performed.

The user enters the DLNA list by clicking the shortcut icon and operable DLNA apparatuses are listed out in the DLNA list so that the user can select and operate a corresponding DLNA apparatus depending on his or her own needs.

According to the above descriptions, the method of displaying a DLNA apparatus and a mobile terminal of the present disclosure allow the user to enter a DLNA list by clicking a shortcut icon on the display interface so as to select and operate the DLNA apparatus, which can simplify the operation steps; and because the user can directly enter the DINA list in the display interface, it is more convenient for the user to operate and the operation efficiency of the user on the DLNA apparatus can be enhanced.

What described above are only the embodiments of the present disclosure, but are not intended to limit the scope of the present disclosure .Any equivalent structures or equivalent process flow modifications that are made according to the specification and the attached drawings of the present disclosure, or any direct or indirect applications of the present disclosure in other related technical fields shall all be covered within the scope of the present disclosure.

What is claimed is:

1. A method of displaying a DLNA apparatus, comprising:
accessing a DLNA network via a wireless mode;
acquiring a DLNA apparatus in the DLNA network;
determining whether the DLNA apparatus is in a connectable status, and adding the DLNA apparatus to a DLNA list if the DLNA apparatus is in a connectable status, or acquiring other DLNA apparatuses in the DLNA network if the DLNA apparatus is not in a connectable status, wherein the DLNA list is correspondingly related to a shortcut icon;
concealing the shortcut icon in a display interface, calling the shortcut icon in response to a user's activation operation on the display interface, and displaying the shortcut icon at a predetermined position;
entering the DLNA list by clicking the shortcut icon to select and operate the DLNA apparatus.

2. The method of claim I, wherein the display interface is a touch interface, and the activation operation is a downward sliding action from the predetermined position.

3. The method of claim 1, wherein the DLNA network is a wireless network or a wired network.

4. A mobile terminal, comprising an accessing module, an acquiring module, an adding module, a displaying module and a selecting module, wherein:
the accessing module is configured to access a DLNA network via a wireless mode;
the acquiring module is configured to acquire a DLNA apparatus in the DLNA network;
the adding module is configured to add the DLNA apparatus to a DLNA list, wherein the DLNA list is correspondingly related to a shortcut icon;
the displaying module is configured to display the shortcut icon at a predetermined position on a display interface; and
the selecting module is configured to enter the DLNA list by clicking the shortcut icon to select and operate the DLNA apparatus.

5. The mobile terminal of claim 4, wherein the adding module is specifically configured to determine whether the DLNA apparatus is in a connectable status, and add the DLNA apparatus to the DLNA list if the DLNA apparatus is in a connectable status, or acquire other DLNA apparatuses in the DLNA network if the DLNA apparatus is not in a connectable status.

6. The mobile terminal of claim 4, wherein the displaying module is specifically configured to conceal the shortcut icon in the display interface, call the shortcut icon in response to a user's activation operation on the display interface, and display the shortcut icon at the predetermined position.

7. The mobile terminal of claim 6, wherein the display interface is a touch interface, and the activation operation is a downward sliding action from the predetermined position.

8. The mobile terminal of claim 4, wherein the DLNA network is a wireless network or a wired network.

9. A method of displaying a DLNA apparatus, comprising the following steps of:
accessing a DLNA network via a wireless mode;
acquiring a DLNA apparatus in the DLNA network;
adding the DLNA apparatus to a DLNA list, wherein the DLNA list is correspondingly related to a shortcut icon;
displaying the shortcut icon at a predetermined position on a display interface; and
entering the DLNA list by clicking the shortcut icon to select and operate the DLNA apparatus.

10. The method of claim 9, wherein the step of adding the DLNA apparatus to a DLNA list is specifically as follows:
determining whether the DLNA apparatus is in a connectable status, and adding the DLNA apparatus to the DLNA list if the DLNA apparatus is in a connectable status, or acquiring other DLNA apparatuses in the DLNA network if the DLNA apparatus is not in a connectable status.

11. The method of claim 9, wherein the step of displaying the shortcut icon at a predetermined position on a display interface comprises:
concealing the shortcut icon in the display interface;
calling the shortcut icon in response to a user's activation operation on the y interface; and
displaying the shortcut icon at the predetermined position.

12. The method of claim 11, wherein the display interface is a touch interface, and the activation operation is a downward sliding action from the predetermined position.

13. The mobile terminal of claim 9, wherein the DLNA network is a wireless network or a wired network.

14. A mobile terminal, comprising an accessing module, an acquiring module, an adding module, a displaying module and a selecting module, wherein:
the accessing module is configured to access a DLNA network via a wireless mode;
the acquiring module is configured to acquire a DLNA apparatus in the DLNA network;
the adding module is configured to add the DLNA apparatus to a DLNA list, wherein the DLNA list is correspondingly related to a shortcut icon;
the displaying module is configured to display the shortcut icon at a predetermined position on a display interface; and
the selecting module is configured to enter the DLNA list by clicking the shortcut icon to select and operate the DLNA apparatus.

15. The mobile terminal of claim 14, wherein the adding module is specifically configured to determine whether the DLNA apparatus is in a connectable status, and add the DLNA apparatus to the DLNA list if the DLNA apparatus is in a connectable status, or acquire other DLNA apparatuses in the DLNA network if the DLNA apparatus is not in a connectable status.

16. The mobile terminal of claim 14, wherein the displaying module is specifically configured to conceal the shortcut icon in the display interface; call the shortcut icon in response to a user's activation operation on the display interface; and display the shortcut icon at the predetermined position.

17. The mobile terminal of claim 16, wherein the display interface is a touch interface, and the activation operation is a downward sliding action from the predetermined position.

18. The mobile terminal of claim 14, wherein the DLNA network is a wireless network or a wired network.
